(19) United States
(12) Patent Application Publication
(10) Pub. No.: US 2025/0370802 A1
(43) Pub. Date: Dec. 4, 2025

(54) ELECTRONIC DEVICE AND CONTROLLING METHOD THEREOF

(71) Applicant: Samsung Electronics Co., Ltd., Suwon-si (KR)

(72) Inventors: Minyoung KANG, Suwon-si (KR); Taegeon UM, Suwon-si (KR); Byungsoo OH, Suwon-si (KR); Wooyeon LEE, Suwon-si (KR)

(21) Appl. No.: 19/215,839

(22) Filed: May 22, 2025

Related U.S. Application Data
(63) Continuation of application No. PCT/KR2025/005106, filed on Apr. 15, 2025.

(30) Foreign Application Priority Data
May 31, 2024 (KR) 10-2024-0071554
Oct. 8, 2024 (KR) 10-2024-0136304

(51) Int. Cl. G06F 9/50; G06F 9/38

(52) U.S. Cl. CPC G06F 9/5016; G06F 9/3867

(57) ABSTRACT

An electronic device and a controlling method thereof are provided. The electronic device includes memory, comprising one or more storage media, storing instructions and configured to store information on a neural network model and information on a plurality of resources for performing distributed learning on the neural network model, and a processor communicatively coupled to the memory and configured to perform a parallelism process including pipeline parallelism, data parallelism, and tensor parallelism based on the information on the neural network model and the information on the plurality of resources, wherein the instructions, when executed by the processor, cause the electronic device to acquire a first computation amount when performing the distributed learning from a time when a change in the plurality of resources is detected to a next checkpoint using the plurality of resources before the change, if the change is detected while performing the distributed learning according to a result of performing the parallelism process, perform the parallelism process again based on the information on the plurality of changed resources, acquire a second computation amount when performing the distributed learning from the time when the change is detected to the next checkpoint using the plurality of changed resources, as the result of the parallelism performed again, and perform the distributed learning by a method corresponding to a smaller computation amount of the first computation amount and the second computation amount.

### CROSS-REFERENCE TO RELATED APPLICATION(S)

This application is a continuation application, claiming priority under 35 U.S.C. § 365 (c), of an International application No. PCT/KR2025/005106, filed on Apr. 15, 2025, which is based on and claims the benefit of a Korean patent application number 10-2024-0071554, filed on May 31, 2024, in the Korean Intellectual Property Office, and of a Korean patent application number 10-2024-0136304, filed on Oct. 8, 2024, in the Korean Intellectual Property Office, the disclosure of each of which is incorporated by reference herein in its entirety.

### BACKGROUND OF THE INVENTION

### Field of the Invention

The disclosure relates to an electronic device and a controlling method of the electronic device. More particularly, the disclosure relates to an electronic device capable of performing a parallel process using a plurality of resources and performing distributed learning on a neural network model, and a controlling method thereof.

### Description of the Related Art

Recently, technologies related to artificial intelligence have been developing rapidly, and accordingly, technologies for efficiently utilizing resources (e.g., graphics processing units (GPUs) used for training neural network models have been attracting attention.

In particular, various parallelism methods have been used recently to perform the distributed learning on the neural network models using a plurality of resources. However, it has been pointed out that the technology of the related art has a limitation in that it may not perform the distributed learning in an efficient manner in response to various resource environments.

For example, when the plurality of resources do not include the same GPU but of heterogeneous GPUs with different performance, or when the number of resources is changed while performing the distributed learning using the plurality of resources, it has been pointed out that it is difficult to perform the efficient distributed learning using the technology of the related art in various resource environments.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide an electronic device capable of performing parallelism in an efficient manner in response to various resource environments and performing distributed learning on a neural network model, and a controlling method thereof.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions and configured to store information on a neural network model and information on a plurality of resources for performing distributed learning on the neural network model and a processor communicatively coupled to the memory and configured to perform a parallelism process including pipeline parallelism, data parallelism, and tensor parallelism based on the information on the neural network model and the information on the plurality of resources, wherein the instructions, when executed by the processor, cause the electronic device to acquire a first computation amount when performing the distributed learning from a time when a change in the plurality of resources is detected to a next checkpoint using the plurality of resources before the change, if the change is detected while performing the distributed learning according to a result of performing the parallelism process, perform the parallelism process again based on the information on the plurality of changed resources, acquire a second computation amount when performing the distributed learning from the time when the change is detected to the next checkpoint using the plurality of changed resources, as the result of the parallelism performed again, and perform the distributed learning by a method corresponding to a smaller computation amount of the first computation amount and the second computation amount.

The instructions, when executed by the processor, further cause the electronic device to acquire a third computation amount when performing the distributed learning from the checkpoint before the time when the change is detected to the next checkpoint using the plurality of changed resources, as the result of the parallelism performed again, and perform the distributed learning by a method corresponding to the smallest computation amount among a sum of a fourth computation amount and the first computation amount, a sum of the fourth computation amount and the second computation amount, and the third computation amount from a previous checkpoint to the time when the change is detected.

The instructions, when executed by the processor, further cause the electronic device to perform the pipeline parallelism to identify a plurality of combinations that allocate the plurality of resources to a plurality of stages that divide layers included in the neural network model, determine at least one resource performing the data parallelism and at least one resource performing the tensor parallelism among the plurality of resources so that a ratio of the data parallelism is maximized to determine each candidate parallelism method of each of the plurality of combinations, identify an optimal parallelism method among the candidate parallelism methods as a result of performing the parallelism process based on an execution time of the distributed learning according to each of the candidate parallelism methods identified for each of the plurality of combinations, and perform the distributed learning on the neural network model based on the optimal parallelism method.

The instructions, when executed by the processor, further cause the electronic device to identify whether there is a resource exceeding memory usage among the plurality of resources when performing the distributed learning according to a first parallelism method in which the ratio of the data parallelism is maximized, and determine the first parallelism method as the candidate parallelism method when it is identified that there is no resource exceeding the memory usage.

The instructions, when executed by the processor, further cause the electronic device to determine a second parallelism method in which the first parallelism method is changed by reallocating the layers to the plurality of resources so that the memory usage does not exceed when it is identified that there is the resource exceeding the memory usage, and determine the second parallelism method as the candidate parallelism method.

The instructions, when executed by the processor, further cause the electronic device to determine a third parallelism method having a ratio of the data parallelism that is next higher than that of the first parallelism method when it is identified that there is the resource exceeding the memory usage, and determine the third parallelism method as the candidate parallelism method.

The instructions, when executed by the processor, further cause the electronic device to determine the candidate parallelism method among the second parallelism method and the third parallelism method based on the execution time of the distributed learning according to each of the second parallelism method and the third parallelism method.

When there is a stage including two or more resources having different performance among a plurality of stages, the instructions, when executed by the processor, further cause the electronic device to allocate the plurality of resources to the plurality of stages based on the performances of the two or more resources.

The information on the plurality of resources includes information on processing performance of each of the plurality of resources, a bandwidth between the plurality of resources, and a bandwidth between the plurality of stages.

The instructions, when executed by the processor, further cause the electronic device to calculate the execution time by performing the distributed learning on each of the candidate parallelism methods for a predetermined time.

In accordance with another aspect of the disclosure, a method of controlling an electronic device is provided. The method includes performing a parallelism process including pipeline parallelism, data parallelism, and tensor parallelism based on information on a neural network model and information on a plurality of resources for performing distributed learning on the neural network model, acquiring a first computation amount when performing the distributed learning from a time when a change in the plurality of resources is detected to a next checkpoint using the plurality of resources before the change, if the change is detected while performing the distributed learning according to a result of performing the parallelism process, performing the parallelism process again based on the information on the plurality of changed resources, acquiring a second computation amount when performing the distributed learning from the time when the change is detected to the next checkpoint using the plurality of changed resources, as the result of the parallelism performed again, and performing the distributed learning by a method corresponding to a smaller computation amount of the first computation amount and the second computation amount.

The method further includes calculating a third computation amount when performing the distributed learning from a checkpoint before the time when the change is detected to the next checkpoint using the plurality of changed resources, as the result of the parallelism performed again, and performing the distributed learning by a method corresponding to the smallest computation amount among a sum of a fourth computation amount and the first computation amount, a sum of the fourth computation amount and the second computation amount, and the third computation amount from the previous checkpoint to the time when the change is detected.

The method further includes performing the pipeline parallelism to identify a plurality of combinations that allocate the plurality of resources to a plurality of stages that divide layers included in the neural network model, determining at least one resource performing the data parallelism and at least one resource performing the tensor parallelism among the plurality of resources so that a ratio of the data parallelism is maximized to determine each candidate parallelism method of each of the plurality of combinations, identifying an optimal parallelism method among the candidate parallelism methods as a result of performing the parallelism process based on an execution time of the distributed learning according to each of the candidate parallelism methods identified for each of the plurality of combinations, and performing the distributed learning on the neural network model based on the optimal parallelism method.

The determining of each of the candidate parallelism methods for each of the plurality of combinations includes identifying whether there is a resource exceeding memory usage among the plurality of resources when performing the distributed learning according to a first parallelism method in which the ratio of the data parallelism is maximized, and determining the first parallelism method as the candidate parallelism method when it is identified that there is no resource exceeding the memory usage.

The determining of each of the candidate parallelism methods for each of the plurality of combinations includes determining a second parallelism method in which the first parallelism method is changed by reallocating the layers to the plurality of resources so that the memory usage does not exceed when it is identified that there is the resource exceeding the memory usage, and determining the second parallelism method as the candidate parallelism method.

The determining of each of the candidate parallelism method of each of the plurality of combinations further includes determining the third parallelism method having a ratio of the data parallelism that is next higher than that of the first parallelism method when it is identified that there is the resource exceeding the memory usage, and determining the third parallelism method as the candidate parallelism method.

The determining of each of the candidate parallelism method of each of the plurality of combinations further includes determining the candidate parallelism method among the second parallelism method and the third parallelism method based on the execution time of the distributed learning according to each of the second parallelism method and the third parallelism method.

In the identifying of the plurality of combinations, when there is a stage including two or more resources having different performance among a plurality of stages, the plurality of resources are allocated to the plurality of stages based on the performances of the two or more resources.

The information on the plurality of resources includes information on processing performance of each of the plurality of resources, a bandwidth between the plurality of resources, and a bandwidth between the plurality of stages.

The identifying of the optimal parallelism method includes calculating the execution time by performing the distributed learning on each of the candidate parallelism methods for a predetermined time.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include performing a parallelism process including pipeline parallelism, data parallelism, and tensor parallelism based on information on a neural network model and information on a plurality of resources for performing distributed learning on the neural network model, acquiring a first computation amount when performing the distributed learning from a time when a change in the plurality of resources is detected to a next checkpoint using the plurality of resources before the change, if the change is detected while performing the distributed learning according to a result of performing the parallelism process, performing the parallelism process again based on the information on the plurality of changed resources, acquiring a second computation amount when performing the distributed learning from the time when the change is detected to the next checkpoint using the plurality of changed resources, as the result of the parallelism performed again, and performing the distributed learning by a method corresponding to a smaller computation amount of the first computation amount and the second computation amount.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device and a plurality of resources according to an embodiment of the disclosure;

FIG. 2 is a block diagram schematically illustrating a configuration of an electronic device according to an embodiment of the disclosure;

FIG. 3 is a diagram illustrating one or more embodiments related to identifying an optimal distributed learning method when a change in a plurality of resources is detected according to an embodiment of the disclosure;

FIGS. 4 and 5 are diagrams illustrating one or more embodiments related to identifying an optimal parallelism method based on prioritizing data parallelism for each of a plurality of stages according to various embodiments of the disclosure;

FIG. 6 is a diagram illustrating one or more embodiments related to determining a candidate parallelism method based on whether there is a resource exceeding memory usage among a plurality of resources according to an embodiment of the disclosure;

FIG. 7 is a block diagram illustrating a configuration of an electronic device according to an embodiment of the disclosure; and

FIG. 8 is a flowchart illustrating a controlling method of an electronic device according to an embodiment of the disclosure.

Throughout the drawings, it should be noted that like reference numbers are used to depict the same or similar elements, features, and structures.

### MODE FOR IMPLEMENTING THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the disclosure, when it is determined that a detailed description for the known functions or configurations related to the disclosure may unnecessarily obscure the gist of the disclosure, the detailed description therefor will be omitted.

In addition, the following embodiments may be modified in multiple different forms, and the scope and spirit of the disclosure are not limited to the following embodiments. Rather, these embodiments make the disclosure thorough and complete, and are provided to completely transfer a technical spirit of the disclosure to those skilled in the art.

Terms used in the disclosure are used only to describe specific embodiments rather than limiting the scope of the disclosure. Singular forms include plural forms unless the context clearly indicates otherwise.

In the specification, an expression “have”, “may have”, “include”, “may include”, or the like, indicates existence of a corresponding feature (for example, a numerical value, a function, an operation, a component, such as a part, or the like), and does not exclude existence of an additional feature.

In the disclosure, an expression “A or B”, “at least one of A and/or B”, or “one or more of A and/or B”, may include all possible combinations of items enumerated together. For example, “A or B”, “at least one of A and B”, or “at least one of A or B” may indicate all of 1) a case where at least one A is included, 2) a case where at least one B is included, or 3) a case where both of at least one A and at least one B are included.

Expressions “first” or “second” used in the disclosure may indicate various components regardless of a sequence and/or importance of the components, will be used only to distinguish one component from the other components, and do not limit the corresponding components.

When it is mentioned that any component (for example, a first component) is (operatively or communicatively) coupled with/to or is connected to another component (for example, a second component), it is to be understood that any component is directly coupled to another component or may be coupled to another component through the other component (for example, a third component).

On the other hand, when it is mentioned that any component (for example, a first component) is “directly coupled” or “directly connected” to another component (for example, a second component), it is to be understood that the other component (for example, a third component) is not present between any component and another component.

An expression “configured (or set) to” used in the disclosure may be replaced by an expression “suitable for”, “having the capacity to” “designed to”, “adapted to”, “made to”, or “capable of” depending on a situation. A term “configured (or set) to” may not necessarily mean “specifically designed to” in hardware.

Instead, in some situations, an expression “apparatus configured to” may mean that the apparatus may “do” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in memory.

In embodiments of the disclosure, a ‘module’ or a ‘˜er/or’ may perform at least one function or operation, and be implemented by hardware or software or be implemented by a combination of hardware and software. In addition, a plurality of “modules” or a plurality of “˜ers/ors” may be integrated in at least one module and be implemented by at least one processor except for a ‘module’ or an ‘˜er/or’ that needs to be implemented by specific hardware.

Meanwhile, various elements and regions in the drawings are schematically illustrated. Therefore, the spirit of the disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

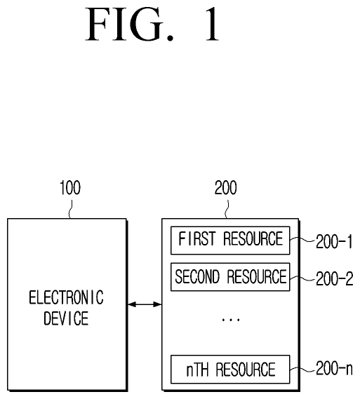

FIG. 1 is a block diagram illustrating an electronic device and a plurality of resources according to an embodiment of the disclosure.

Referring to FIG. 1, a system according to the disclosure may include an electronic device 100 and the plurality of resources.

The ‘electronic device 100’ refers to a device that performs a parallel process using the plurality of resources and performs distributed learning on a neural network model. For example, the electronic device 100 may be a server, but there is no particular limitation on the type of the electronic device 100.

The ‘resource’ may include a computing resource for performing various functions, such as specific calculations or tasks. For example, the resource may include a hardware configuration, such as a graphics processing unit (GPU), a neural processing unit (NPU), or the like.

In FIG. 1, it is assumed that at least one external device connected to the electronic device 100 includes the plurality of resources, and the plurality of resources are illustrated as existing outside the electronic device 100. However, the disclosure is not limited thereto, and at least some of the plurality of resources may be components included in the electronic device 100 (e.g., a GPU included in the electronic device 100).

There is no particular limitation on the number and type of the plurality of resources, and for example, at least one of the plurality of resources may have different performance (e.g., computational speed, memory 110 capacity, bandwidth, or the like) from other resources. In other words, the plurality of resources may include heterogeneous resources.

The ‘neural network model’ is a model implemented based on the neural network of the human brain, and may refer to the entire model in which artificial neurons formed by combining synapses form a network and change the strength of the synapses through the learning to have problem-solving capabilities. The neural network model may include a plurality of layers (or strata), and for example, may include an input layer, an output layer, and a plurality of hidden layers therebetween. The neural network model may include an artificial neural network (ANN) model, a deep neural network (DNN) model, or the like. However, there is no special restriction on the type of neural network model.

The ‘distributed learning’ is a method of learning by dividing a neural network model or data using the plurality of resources (or a plurality of devices including the plurality of resources, a plurality of nodes, or a plurality of machines), and may be performed using various types of parallelism processes.

‘Parallelism’ refers to a method of performing distributed learning in parallel by dividing a neural network model among the plurality of resources. Here, the parallelism process may include data parallelism and model parallelism, and the model parallelism may include pipeline parallelism and tensor parallelism.

The ‘data parallelism’ is a technique for parallel processing training data to a neural network model. In other words, the data parallelism is a technique for training a neural network model by allocating the entire neural network model to each of the plurality of resources, dividing the entire training data into a certain number of batches, and allocating the training data to each resource.

The ‘pipeline parallelism’ is a technique for dividing a neural network model into layers and processing the neural network model in parallel. In other words, the pipeline parallelism is a technique for dividing the plurality of resources included in the neural network model into the plurality of stages and allocating each of the plurality of stages to resources to train the neural network model.

The ‘tensor parallelism’ is a technique for dividing layers included in a neural network model and processing the layers in parallel. In other words, the tensor parallelism is a technique for dividing the plurality of layers included in the neural network model and allocating the layers to the plurality of resources to train the neural network model. The tensor parallelism is a method of dividing one layer into a plurality of resources and allocating the layer to the plurality of resources, rather than dividing the layer into the plurality of layers like the pipeline parallelism, and may require a sync operation that combines outputs of intermediate or final layers.

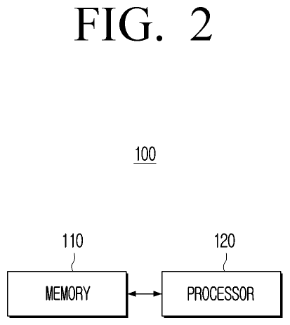

In the above, the electronic device 100 according to an embodiment of the disclosure and the description of the main terms related to the disclosure along with the description of the plurality of resources are described. Hereinafter, various embodiments according to the disclosure will be described with reference to FIGS. 2 to 8.

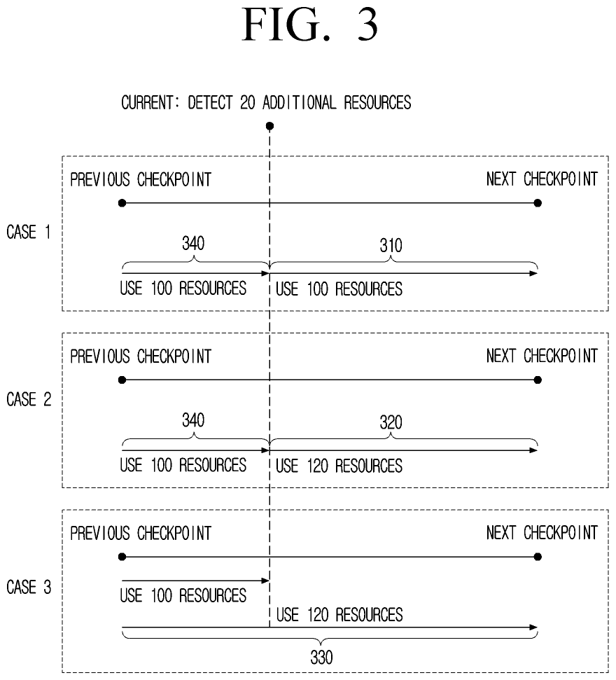

FIG. 2 is a block diagram schematically illustrating a configuration of an electronic device according to an embodiment of the disclosure. FIG. 3 is a diagram illustrating one or more embodiments related to identifying an optimal distributed learning method when a change in a plurality of resources is detected according to an embodiment of the disclosure.

Referring to FIG. 2, the electronic device 100 according to an embodiment of the disclosure may include the memory 110 and a processor 120.

At least one instruction regarding the electronic device 100 may be stored in the memory 110. In addition, an operating system (O/S) for driving the electronic device 100 may be stored in the memory 110. In addition, various software programs or applications for operating the electronic device 100 according to diverse embodiments of the disclosure may also be stored in the memory 110. In addition, the memory 110 may include semiconductor memory, such as flash memory or the like, or magnetic storing medium, such as hard disk or the like.

Specifically, the memory 110 may store various software modules for operating the electronic device 100 according to diverse embodiments of the disclosure, and the processor 120 may run various software modules stored in the memory 110 to control an operation of the electronic device 100. For example, the memory 110 may be accessed by the processor 120, and readout, recording, correction, deletion, update, and the like, of data in the memory 110 may be performed by the processor 120.

Meanwhile, in the disclosure, the term “memory 110” may be used as the meaning including the memory 110, read only memory (ROM) in the processor 120, random access memory (RAM), or memory card (for example, micro secure digital (SD) card or memory stick) mounted in the electronic device 100.

In one or more embodiments of the disclosure, information on the neural network model and information on the plurality of resources for performing the distributed learning on the neural network model may be stored in the memory 110. Here, the ‘information on the neural network model’ may include information on layers included in the neural network model, information on parameters including weights, and the like. ‘The information on the plurality of resources’ may include information on processing performance of each of the plurality of resources, a bandwidth between the plurality of resources, and a bandwidth between the plurality of stages.

In addition, various information, such as information on the result of performing the parallelism process according to the disclosure, information on a first computation amount, information on a second computation amount, information on a third computation amount, information on a plurality of combinations, information on candidate parallelism methods, and information on the memory 110 usage according to a candidate parallelism method, may be stored in the memory 110.

In addition, various pieces of information necessary within the scope for achieving the object of the disclosure may be stored in the memory 110, and the information stored in the memory 110 may be updated as received from an external device or input by a user.

The processor 120 controls a general operation of the electronic device 100. Specifically, the processor 120 is connected to the configuration of the electronic device 100 including the memory 110, and executes at least one instruction stored in the memory 110 as described above to control the overall operation of the electronic device 100.

The processor 120 may be implemented in various manners. For example, the processor 120 may be implemented by at least one of an application specific integrated circuit (ASIC), an embedded processor, a microprocessor, a hardware control logic, a hardware finite state machine (FSM), or a digital signal processor (DSP). Meanwhile, in the disclosure, the term processor 120 may be used as meaning including a central processing unit (CPU), a graphics processing unit (GPU), a micro processing unit (MPU), and the like.

In one or more embodiments of the disclosure, the processor 120 may perform a parallelism process including the pipeline parallelism, the data parallelism, and the tensor parallelism based on the information on the neural network model and the information on the plurality of resources.

Specifically, the processor 120 may perform the parallelism process so that the processing and calculation of data performed by the neural network model are allocated to the plurality of resources so that the plurality of resources may not exceed the memory usage of the plurality of resources while exhibiting maximum performance.

A specific description of the parallelism process will be given later. Hereinafter, an example of a case in which the change occurs to the plurality of resources while the distributed learning is performed after the parallelism process is performed will be described first.

The processor 120 may detect the change in the plurality of resources while performing the distributed learning as the results of performing the parallelism process.

Specifically, the processor 120 may detect the change in the plurality of resources based on at least one of an error occurring while performing the distributed learning, an increase in available resources, and a decrease in available resources. For example, the processor 120 may detect that the number of resources changes to 120 while performing the distributed learning as the result of performing the parallelism process when the number of resources is 100.

When the change in the plurality of resources is detected, the processor 120 may acquire the first computation amount for performing the distributed learning from the time when the change in the plurality of resources is detected to the next checkpoint using the plurality of resources before the change. For example, even if the change in the plurality of resources is detected, the processor 120 may estimate the computation amount for continuing the distributed learning as the result of the parallelism process performed based on the information on the plurality of resources before the change.

Referring to CASE 1 of FIG. 3, even if the number of resources changes from 100 to 120, the processor 120 may acquire the first computation amount when performing the distributed learning from the time when the change in the plurality of resources is detected to the next checkpoint under the assumption that 100 resources before the plurality of resources are changed are used. For example, the processor 120 may acquire the first computation amount for section 310 of FIG. 3.

Here, the ‘checkpoint’ refers to the time when the intermediate operation results are saved while performing the distributed learning on the neural network model, and may be set to exist at predetermined cycles. The checkpoint may be changed according to the developer's or user's settings. For example, the checkpoint may be 4 hours, and may be set in various ways depending on the size of the neural network model, the amount of data processed by the neural network model, or the like.

The term ‘computation amount’ refers to the total of computation amounts required while performing the distributed learning, and may be distinguished as the first computation amount, the second computation amount, and the third computation amount depending on the computation amount when performing the distributed learning as the result of the parallelism. Since the computation amount may be converted into ‘required time’ or ‘computation speed’, the term computation amount may be replaced with the term required time or computation speed.

The processor 120 may perform the parallelism process again based on the information on the plurality of changed resources. Specifically, when the change in the plurality of resources is detected, the processor 120 may allocate the processing of data and calculations performed by the neural network model to the plurality of resources so that the plurality of changed resources may not exceed the memory usage of the plurality of resources while exhibiting their maximum performance.

The processor 120 may acquire the second computation amount when performing the distributed learning from the time when the change in the plurality of resources is detected to the next checkpoint using the plurality of changed resources as the result of the parallelism performed again. For example, when the change in the plurality of resources is detected, the processor 120 may estimate the computation amount for continuing the distributed learning as the result of the parallelism process performed based on the information on the plurality of resources after the change.

Referring to CASE 2 of FIG. 3, when the number of resources changes from 100 to 120, the processor 120 may acquire the second computation amount in case of performing the distributed learning from the time when the change in the plurality of resources is detected to the next checkpoint under the assumption that 120 resources after the change in the plurality of resources are used as the result of the parallelism performed again. For example, the processor 120 may acquire the second computation amount for section 320 of FIG. 3.

When the first computation amount and the second computation amount are acquired, the processor 120 may perform the distributed learning in a method corresponding to a smaller computation amount among the first computation amount and the second computation amount.

Meanwhile, in one or more embodiments of the disclosure, the processor 120 may perform the distributed learning by a method corresponding to the smallest computation amount by additionally considering the distributed learning method of another method in addition to the distributed learning method corresponding to each of the first computation amount and the second computation amount.

Specifically, the processor 120 may calculate the third computation amount when performing the distributed learning from a checkpoint before the time when the change in the plurality of resources is detected to the next checkpoint by using the plurality of changed resources according to the re-performed parallelism result.

For example, when the change in the plurality of resources is detected, the processor 120 may estimate the computation amount when performing the distributed learning as the result of the parallelism process performed based on the information on the plurality of resources after the change, by returning to the checkpoint before the time when the plurality of resources are changed, not the time when the plurality of resources are changed.

Referring to CASE 3 of FIG. 3, when the number of resources is changed from 100 to 120, the processor 120 may acquire the third computation amount when performing the distributed learning from the checkpoint before the time when the plurality of resources are changed to the next checkpoint under the assumption that 120 resources after the change in the plurality of resources are used according to the parallelism result performed again. For example, the processor 120 may acquire the third computation amount for section 330 of FIG. 3.

When the first computation amount, the second computation amount, and the third computation amount are acquired, the processor 120 may perform the distributed learning using the parallelism method corresponding to the smallest computation amount among the sum of the fourth computation amount and the first computation amount, the sum of the fourth computation amount and the second computation amount, and the third computation amount from the previous checkpoint to the time when the change in the plurality of resources is detected.

Specifically, the first computation amount and the second computation amount are about the computation amount from the time when the plurality of resources are changed to the next checkpoint, and the period for which the computation amount is calculated is the same. However, the third computation amount is about the computation amount from the previous checkpoint to the next checkpoint, and the period for which the computation amount is calculated is different from the first computation amount and the second computation amount. Therefore, the processor 120 may match the period for which the computation amount is calculated to the period from the previous checkpoint to the next checkpoint, and then compare each computation amount.

In the example of FIG. 3, the processor 120 may compare the sum of the fourth computation amount and the first computation amount, the sum of the fourth computation amount and the second computation amount, and the fourth computation amount for section 340 of FIG. 3 to identify the method corresponding to the smallest computation amount, and perform the distributed learning with the identified parallelism method.

An overhead required to search for a new optimal parallelism process and to change the plurality of resources to operate with the new parallelism process may be included in the second computation amount, and the overhead required to return to the previous checkpoint and perform the distributed learning again may be included in the third computation amount.

Therefore, even if the change in the plurality of resources is detected, the first computation amount may be the smallest when the distributed learning is continued as the results of the parallelism process performed before the change. On the other hand, even if the overhead as above is included in the second computation amount and the third computation amount, if the reduction in the time required to perform the new parallelism process is greater than the overhead, the second computation amount or the third computation amount may be the smallest.

According to the embodiments described above with reference to FIGS. 1 to 3, when the change in the plurality of resources is detected while performing the distributed learning on the neural network model, the electronic device 100 may perform the distributed learning by determining the optimal learning method among continuing the distributed learning using the plurality of resources before the change and performing the distributed learning in various ways using the plurality of changed resources.

Meanwhile, the process of identifying the optimal parallelism method by performing the parallelism process before and after detecting the change in the plurality of resources has not been specifically described above. Various embodiments of the process for identifying the optimal parallelism method will be described below.

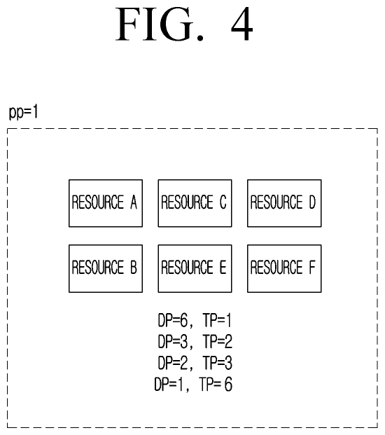

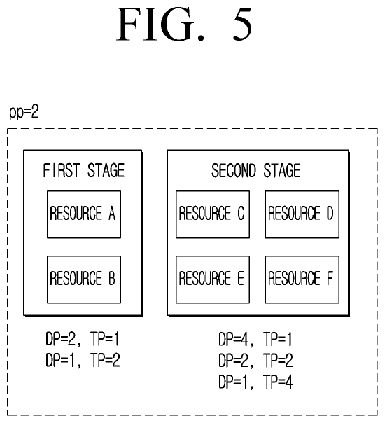

FIGS. 4 and 5 are diagrams illustrating one or more embodiments related to identifying the optimal parallelism method based on prioritizing data parallelism for each of a plurality of stages according to various embodiments of the disclosure.

FIGS. 4 and 5 illustrate cases where the number of resources is 6 and the number of pipeline parallelisms is 1 and 2, respectively. Hereinafter, the pipeline parallelism is abbreviated as PP, the data parallelism as DP, and the tensor parallelism as TP.

In one or more embodiments of the disclosure, the processor 120 may perform the pipeline parallelism to identify the plurality of combinations of allocating the plurality of resources to the plurality of stages that divide layers included in the neural network model.

Specifically, the processor 120 may identify all combinations of dividing the plurality of resources into the plurality of stages and allocating each of the plurality of stages to the resources based on the information on the plurality of resources.

Referring to FIG. 4, the processor 120 may treat six resources as one stage (PP=1), and in this case, six resources may be allocated to one stage, so only one combination is possible.

Referring to FIG. 5, the processor 120 may divide 6 resources into 2 stages (PP=2). In this case, various combinations are possible, but FIG. 5 illustrates a combination in which 2 resources are allocated to the first stage and 4 resources are allocated to the second stage.

The processor 120 may compare the processing performance of each of the plurality of resources and the computation amount of each of the layers included in the neural network model to allocate the layers to the plurality of resources. In addition, the processor 120 may identify the plurality of combinations in which the plurality of resources are allocated to the plurality of stages based on the bandwidth between the plurality of resources and the bandwidth between the plurality of stages as well as the processing performance of each of the plurality of resources.

For example, the processor 120 may allocate 10 layers out of 30 layers included in the neural network model to the first stage and 20 layers to the second stage based on the fact that the processing performance of the second stage is twice that of the first stage.

Meanwhile, when there is a stage among the plurality of stages that includes two or more resources with different performance, the processor 120 may allocate the plurality of resources to the plurality of stages based on the performances of the two or more resources.

For example, when resource A and resource B included in the first stage of FIG. 5 are different types of GPUs from resource C, resource D, resource E, and resource F included in the second stage, the processor 120 may allocate the plurality of resources to the first stage and the second stage based on the processing performance of different types of GPUs.

When the plurality of combinations are identified, the processor 120 may determine the candidate parallelism methods for each of the plurality of combinations by determining at least one resource that performs the data parallelism and at least one resource that performs the tensor parallelism among the plurality of resources so that the ratio of the data parallelism is maximized.

Referring to FIG. 4, when 6 resources are treated as 1 stage (PP=1), a parallelism method in which DP is 6 and TP is 1, a parallelism method in which DP is 3 and TP is 2, a parallelism method in which DP is 2 and TP is 3, and a parallelism method in which DP is 1 and TP is 6 are possible.

Determining the parallelism method so that the ratio of the data parallelism is maximized may mean that among the above parallelism methods, the parallelism method in which DP is 6 and TP is 1 is preferentially considered. This is because, as the ratio of DP increases, the amount of memory usage increases, but the processing performance improves.

Specifically, the processor 120 preferentially selects the parallelism method with the highest DP value among the parallelism methods according to all the possible combinations of DP and TP, and when performing the distributed learning according to the selected parallelism method, if there is no resource that exceeds the memory usage among the plurality of resources, the selected parallelism method may be determined as the candidate parallelism method of the corresponding combination.

For example, the processor 120 may determine a parallelism method in which PP is 1, DP is 6, and TP is 1 among all cases described in FIG. 4 as the candidate parallelism method of the corresponding combination. In addition, the processor 120 may determine a parallelism method in which PP is 2, DP of the first stage is 2, TP is 1, and DP of the second stage is 4 and TP is 1 among all the cases described in FIG. 4 as the candidate parallelism method of the corresponding combination.

The processor 120 may identify the optimal parallelization method among the candidate parallelization methods as a result of performing the parallelization process based on an execution time of the distributed learning according to each of the candidate parallelization methods identified for each of the plurality of combinations. In addition, the processor 120 may perform the distributed learning on the neural network model based on the optimal parallelism method.

Specifically, the candidate parallelism method with the shortest execution time of the distributed learning according to each of the candidate parallelism methods identified for each of the plurality of combinations may be identified as the optimal parallelism method, and the distributed learning on the neural network model may be performed using the optimal parallelism method.

The processor 120 may calculate the execution time of the distributed learning on each candidate parallelism method based on the information on layers included in the neural network model, the information on the plurality of resources, or the like. In addition, the processor 120 may calculate the execution time by performing the distributed learning on each candidate parallelism method for a predetermined period of time. In other words, the processor 120 may calculate the execution time of the distributed learning on each candidate parallelism method by using the information stored in the memory 110, and may actually calculate the execution time by directly performing the distributed learning on each candidate parallelism method for a predetermined period of time.

For example, in the example of FIG. 4, when a parallelism method in which PP is 1, DP is 6, and TP is 1 is determined as a first candidate parallelism method, and in the example of FIG. 5, when a parallelism method in which PP is 2, DP of the first stage is 2, TP is 1, and DP of the second stage is 4 and TP is 1 is determined as a second candidate parallelism method, the processor 120 may identify the candidate parallelism method with a shorter execution time among the first candidate parallelism method and the second candidate parallelism method as the optimal parallelism method to perform the distributed learning.

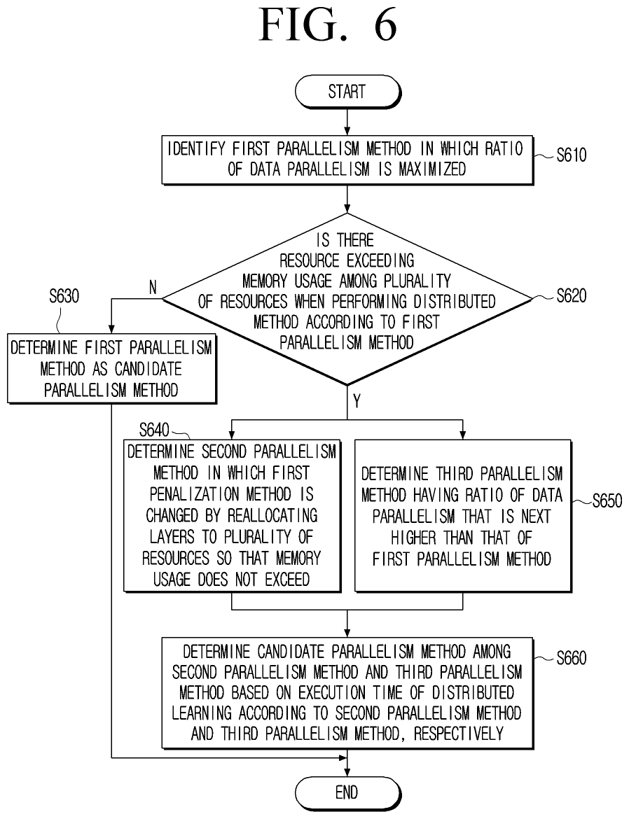

The process of determining the parallelism method so that the ratio of data parallelism is maximized has been briefly described above, which will be described in more detail below with reference to FIG. 6.

FIG. 6 is a diagram illustrating one or more embodiments related to determining a candidate parallelism method based on whether there is a resource exceeding memory usage among the plurality of resources according to an embodiment of the disclosure.

The processor 120 may identify the first parallelism method with the maximum ratio of the data parallelism at operation S610. Hereinafter, it will be described the case where the parallelism method is the first parallelism method in which PP is 2, DP of the first stage is 2 and TP is 1, and DP of the second stage is 4 and TP is 1 in the example of FIG. 5.

The processor 120 may identify whether there is a resource exceeding the memory usage among the plurality of resources when performing the distributed learning according to the first parallelism method at operation S620. Specifically, the processor 120 may identify whether there is an out of memory (OOM) resource for each of the plurality of resources by estimating the memory usage based on the information on the memory of each of the plurality of resources or monitoring the memory usage using the sensors included in each of the plurality of resources.

When it is identified that there is no resource that exceeds the memory usage at operation S620-N, the processor 120 may determine the first parallelism method as the candidate parallelism method at operation S630. For example, when there is no memory shortage for the parallelism method determined to maximize the ratio of the data parallelism, the processor 120 may determine the parallelism method as the candidate parallelism method of the corresponding combination.

When it is identified that there is the resource whose memory usage exceeds at operation S620-Y, the processor 120 may determine the second parallelism method in which the first parallelism method is changed by reallocating the layers to the plurality of resources so that the memory usage does not exceed at operation S640. In other words, when there is memory shortage for the parallelism method determined to maximize the ratio of the data parallelism, it may not be said that the optimal parallelism method has been identified in the combination. Therefore, in this case, the processor 120 may determine another parallelism method by reallocating the layers to the plurality of resources.

In the above example, when the memory usage of at least one of the resources included in the first stage exceeds and the memory usage of the resources included in the second stage does not exceed, it may be said that it is preferable to allocate some of the layers allocated to the first stage to the second stage.

In this case, when 10 layers out of 30 layers included in the neural network model are allocated to the first stage and 20 layers are allocated to the second stage, the processor 120 may determine the second parallelism method by allocating 9 layers to the first stage and 21 layers to the second stage.

When it is identified that there is the resource that exceeds the memory usage at operation S620-Y, the processor 120 may determine the third parallelism method having the ratio of the second highest data parallelism after the first parallelism method at operation S650. For example, when there is the resource that exceeds the memory usage, the processor 120 may reallocate the layers to the plurality of resources, but may change the parallelism method by maintaining the layers reallocated to the plurality of layers and reducing the ratio of the data parallelism.

As in the example above, when the memory usage of at least one of the resources included in the first stage exceeds and the memory usage of the resources included in the second stage does not exceed, the processor 120 may determine the third parallelism method by changing the parallelism method to the parallelism method in which the DP of the first stage is 1 and the TP is 2.

The processor 120 may determine the candidate parallelism method among the second parallelism method and the third parallelism method based on the execution time of the distributed learning according to each of the second parallelism method and the third parallelism method at operation S660. For example, which of the second parallelism method and the third parallelism method is the optimal parallelism method in the combination may be determined based on the execution time of the distributed learning according to each parallelism method.

In the example above, the second parallelism method by reallocating the layers to the plurality of resources and the third parallelism method by reducing the ratio of the data parallelism may be determined as the candidate parallelism method of the combination, which has a shorter execution time of the distributed learning.

Meanwhile, when performing the distributed learning according to the second parallelism method or the third parallelism method, if it is identified that there is the resource that exceeds the memory usage, the processor 120 may reallocate the layers to the plurality of resources again as in the above-described embodiment or reduce the ratio of the data parallelism, and this process may be repeated until the parallelism method that has the best processing performance and does not have the memory shortage is determined.

According to the above-described embodiments with reference to FIGS. 4 and 5, the electronic device 100 may perform the distributed learning on the neural network model in an efficient manner by identifying the parallelism method that may maximize the ratio of the data parallelism even in various resource environments.

In particular, when the plurality of resources include heterogeneous resources, the combinations of the pipeline parallelism, the data parallelism, and the tensor parallelism may be very various, and according to the above-described embodiment of the disclosure, the electronic device 100 may identify an optimal and efficient parallelism method among various combinations.

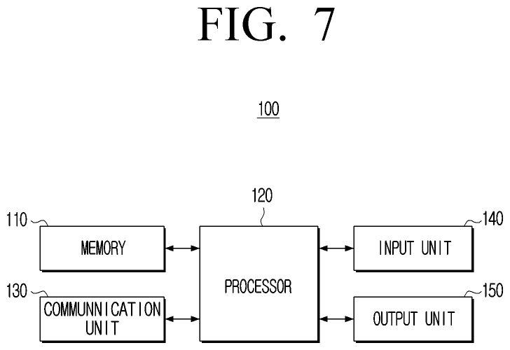

FIG. 7 is a block diagram illustrating a configuration of an electronic device according to an embodiment of the disclosure.

Referring to FIG. 7, the electronic device 100 may further include a communication unit 130, an input unit 140, and an output unit 150 in addition to the memory 110 and the processor 120. However, in carrying out the disclosure, new configurations may be added or some configurations may be omitted in addition to the configurations illustrated in FIGS. 1 and 7.

The communication unit 130 includes a circuit and may perform communication with an external device. Specifically, the processor 120 may receive various data or information from an external device connected through the communication unit 130, and may transmit various data or information to the external device.

The communication unit 130 may include at least one of a Wi-Fi module, a Bluetooth module, a wireless communication module, an NFC module, and an ultra-wide band (UWB) module. Specifically, the Wi-Fi module and the Bluetooth module may each perform communication using Wi-Fi and Bluetooth methods. In the case of using the Wi-Fi module or the Bluetooth module, various connection information, such as SSID, is first transmitted and received, communication is connected using the connection information, and various information may then be transmitted and received.

In addition, the wireless communication module may perform communication depending on various communication protocols, such as institute of electrical and electronics engineers (IEEE), Zigbee, 3^{rd} generation (3G), 3^{rd} generation partnership project (3GPP), long term evolution (LTE), and 5th generation (5G). The NFC module may perform communication in a near field communication (NFC) manner using a band of 13.56 MHz among various radio frequency identification (RFID) frequency bands, such as 135 kHz, 13.56 MHz, 433 MHZ, 860 to 960 MHz, and 2.45 GHz. In addition, the UWB module may accurately measure time of arrival (ToA), which is the time for a pulse to reach a target, and angle of arrival (AoA), which is an angle of arrival of a pulse at the transmitting device, through communication between UWB antennas, so precise distance and position recognition is possible indoors within an error range of several tens of centimeters.

In one or more embodiments of the disclosure, the processor 120 may receive the information on the neural network model, the information on the plurality of resources, the information on the parallelism method, or the like, through the communication unit 130. In addition, the processor 120 may transmit the information on the neural network model on which the distributed learning has been performed to an external device.

The input unit 140 includes a circuit, and the processor 120 may receive user commands for controlling the operation of the electronic device 100 through the input unit 140. Specifically, the input unit 140 may be configured to include components, such as a microphone, a camera, and a remote control signal receiving unit, or the like. The input unit 140 is a touch screen, and may be implemented as the form included in the display. In particular, the microphone may receive voice signals and convert the received voice signals into electrical signals.

In one or more embodiments of the disclosure, the processor 120 may receive a user input, such as a user input for initiating the distributed learning and a user input for transmitting the information on the neural network model to an external device.

The output unit 150 includes a circuit, and the processor 120 may output various functions that the electronic device 100 may perform through the output unit 150. In addition, the output unit 150 may include at least one of a display, a speaker, and an indicator.

The display may output video data under the control of the processor 120. Specifically, the display may output videos pre-stored in the memory 110 under the control of the processor 120. In particular, the display according to one or more embodiments of the disclosure may display a user interface stored in the memory 110. The display may be implemented as a liquid crystal display panel (LCD), organic light emitting diodes (OLED), or the like, and in some cases, the display may also be implemented as a flexible display, a transparent display, or the like. However, the display according to the disclosure is not limited to a specific type.

The speaker may output audio data under the control of the processor 120. The indicator may be turned on under the control of the processor 120. Specifically, the indicator may be turned on in various colors under the control of the processor 120. For example, the indicator may be implemented as light emitting diodes (LEDs), a liquid crystal display panel (LCD), a vacuum fluorescent display (VFD), or the like, but is not limited thereto.

In one or more embodiments of the disclosure, the processor 120 may control the output unit 150 to output the information on the computation amount in case of performing the distributed learning according to each parallelism method, the information on the execution time in case of performing the distributed learning according to each parallelism method, or the like.

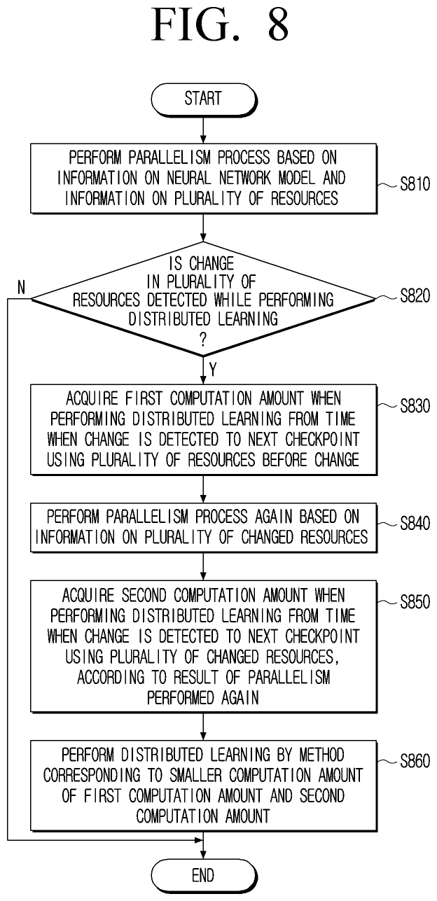

FIG. 8 is a flowchart illustrating a method of controlling an electronic device according to an embodiment of the disclosure.

Referring to FIG. 8, the electronic device 100 may perform the parallelism process based on the information on the neural network model and the information on the plurality of resources at operation S810. Specifically, the electronic device 100 may perform the parallelism process so that the processing and calculation of data performed by the neural network model are allocated to the plurality of resources so that the plurality of resources may not exceed the memory usage of the plurality of resources while exhibiting maximum performance.

The electronic device 100 may detect the change in the plurality of resources while performing the distributed learning at operation S820. Specifically, the electronic device 100 may detect the change in the plurality of resources based on at least one of an error occurring while performing the distributed learning, an increase in available resources, and a decrease in available resources. For example, the electronic device 100 may detect that the number of resources changes to 120 while performing the distributed learning as the result of performing the parallelism process when the number of resources is 100.

The electronic device 100 may acquire the first computation amount when performing the distributed learning from the time when the change is detected to the next checkpoint using the plurality of resources before the change at operation S830. For example, even if the change in the plurality of resources is detected, the electronic device 100 may estimate the computation amount for continuing the distributed learning as the result of the parallelism process performed based on the information on the plurality of resources before the change.

The electronic device 100 may perform the parallelism process again based on the information on the plurality of changed resources at operation S840. Specifically, when the change in the plurality of resources is detected, the electronic device 100 may allocate the processing of data and calculations performed by the neural network model to the plurality of resources so that the plurality of changed resources may not exceed the memory usage of the plurality of resources while exhibiting their maximum performance.

The electronic device 100 may acquire the second computation amount when performing the distributed learning from the time when the change is detected to the next checkpoint using the plurality of changed resources according to the parallelism result performed again at operation S850. For example, when the change in the plurality of resources is detected, the electronic device 100 may estimate the computation amount for continuing the distributed learning as the result of the parallelism process performed based on the information on the plurality of resources after the change.

The electronic device 100 may perform the distributed learning by the method corresponding to the smaller computation amount of the first computation amount and the second computation amount at operation S860.

Meanwhile, the controlling method of the electronic device 100 according to the above-described embodiment may be implemented as a program and provided to the electronic device 100. Particularly, a program including the controlling method of the electronic device 100 may be stored and provided in a non-transitory computer readable medium.

Specifically, in a non-transitory computer-readable recording medium including a program for executing the controlling method of the electronic device 100, the controlling method of an electronic device 100 may include performing the parallelism process including the pipeline parallelism, the data parallelism, and the tensor parallelism based on the information on the neural network model and the information on the plurality of resources for performing the distributed learning on the neural network model, acquiring the first computation amount in the case of performing the distributed learning from the time when the change is detected to the next checkpoint using the plurality of resources before the change when the change is detected to the plurality of resources while performing the distributed learning as the result of performing the parallelism process, performing the parallelism process again based on the information on the plurality of changed resources, acquiring the second computation amount when performing the distributed learning from the time when the change is detected to the next checkpoint using the plurality of changed resources, and performing the distributed learning by the method corresponding to the smaller computation amount of the first computation amount and the second computation amount.

In the above description, the controlling method of the electronic device 100 and the computer-readable recording medium including the program for executing the controlling method of the electronic device 100 have been briefly described, but this is only for omitting redundant description, and of course, various embodiments of the electronic device 100 are also applicable to the computer-readable recording medium including the controlling method of the electronic device 100 and the program for executing the controlling method of the electronic device 100.

A function related to artificial intelligence according to the disclosure is operated through the processor 120 and the memory 110 of the electronic device 100.

The processor 120 may include one or a plurality of processors. In this case, one or more processors 120 may include at least one of a central processing unit (CPU), a graphics processing unit (GPU), and a neural processing unit (NPU), but are not limited to the examples of the processors 120 described above.

The CPU is a general-purpose processor 120 that may perform not only general operations but also artificial intelligence operations, and may efficiently execute complex programs through a multi-layer cache structure. The CPU is advantageous for a serial processing method, which allows organic connection between previous and next operation results through sequential operations. The general-purpose processor 120 is not limited to the above-described examples, except where specified as the above-described CPU.

The GPU is the processor 120 for large-scale operations, such as floating-point operations used in graphics processing, and may perform the large-scale operations in parallel by integrating a large number of cores. More particularly, the GPU may be more advantageous than the CPU in a parallel processing method, such as a convolution operation. In addition, the GPU may be used as the co-processor 120 to supplement the functions of the CPU. The processor 120 for the large-scale operation is not limited to the above-described example, except for the case specified as the above-described GPU.

The NPU is the processor 120 specialized in the artificial intelligence operations using the artificial neural network, and each layer that constitutes the artificial neural network may be implemented in hardware (e.g., silicon). In this case, the NPU is specifically designed according to the company's requirements, so it has a lower degree of freedom than the CPU or GPU, but may efficiently process the artificial intelligence operations requested by the company. Meanwhile, as the processor 120 specialized for the artificial intelligence operations, the NPU may be implemented in various forms, such as a tensor processing unit (TPU), an intelligence processing unit (IPU), and a vision processing unit (VPU). The artificial intelligence processor 120 is not limited to the examples described above, except where specified as the NPU described above.

In addition, one or more processors 120 may be implemented as a System on Chip (SoC). In this case, in addition to one or the plurality of processors 120, the SoC may further include the memory 110 and a network interface, such as a bus for data communication between the processor 120 and the memory 110.

When the system on chip (SoC) included in the electronic device 100 includes the plurality of processors 120, the electronic device 100 may use some of the plurality of processors 120 to perform the artificial intelligence-related operations (e.g., artificial intelligence operations related to model learning or inference). For example, the electronic device 100 may perform the artificial intelligence-related operations using at least one of the GPU, NPU, VPU, TPU, or hardware accelerator specialized for the artificial intelligence operations, such as the convolution operation and the matrix multiplication operation, among the plurality of processors 120. However, this is only an example, and it goes without saying that the artificial intelligence-related operations may be processed using the general-purpose processors 120, such as the CPU.

In addition, the electronic device 100 may perform the operations on the functions related to the artificial intelligence using multi cores (e.g., dual core, quad core, or the like) included in one processor 120. In particular, the electronic device 100 may perform the artificial intelligence operations, such as the convolution operation and the matrix multiplication operation, in parallel using the multi-cores included in the processor 120.

One or more processors 120 perform control to process input data according to a predefined operation rule or artificial intelligence model stored in the memory 110. The predefined operation rule or the AI model is characterized by being made through training.

Here, being created through learning means that a predefined motion rule or an artificial intelligence model of a desired characteristic is created by applying a learning algorithm to a plurality of learning data. Such training may be made in the device itself in which the AI according to the disclosure is performed, or may be made through a separate server/system.

The AI model may include a plurality of neural network layers. At least one layer has at least one weight value, and a calculation of the layers is performed based on a calculation result of a previous layer and at least one defined calculation. Examples of neural networks may include models, such as a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q-networks, and a transformer, and the neural networks in the disclosure are not limited to the above-described examples except for the case specified.

A learning algorithm is a method of training a predetermined target device (e.g., a robot) using a large number of training data so that the predetermined target device may make decisions or make predictions on its own. Examples of the learning algorithms include supervised learning, unsupervised learning, semi-supervised learning, or reinforcement learning, but are not limited to the above examples, and the learning algorithm in the disclosure is not limited to the examples described above except where explicitly stated.

The machine-readable storage medium may be provided in a form of a non-transitory storage medium. Here, the “non-transitory storage medium” means that the storage medium is a tangible device, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored.

According to one or more embodiments of the disclosure, the methods according to various embodiments disclosed in the document may be included and provided in a computer program product. The computer program product may be traded as a product between a seller and a purchaser. The computer program product may be distributed in the form of a machine-readable storage medium (for example, compact disc read only memory (CD-ROM)), or may be distributed through an application store (for example, Play Store™) or may be directly distributed (for example, download or upload) between two user devices (for example, smart phones) online. In a case of the online distribution, at least some of the computer program products (for example, downloadable app) may be at least temporarily stored in a machine-readable storage medium, such as the memory 110 of a server of a manufacturer, a server of an application store, or a relay server, or may be temporarily generated.

Each of components (for example, modules or programs) according to the diverse embodiments of the disclosure as described above may include a single entity or a plurality of entities, and some of the corresponding sub-components described above may be omitted or other sub-components may be further included in the diverse embodiments. Alternatively, or additionally, some of the components (e.g., the modules or the programs) may be integrated into one entity, and may perform functions performed by the respective corresponding components before being integrated in the same or similar manner.

Operations performed by the modules, the programs, or other components according to the diverse embodiments may be executed in a sequential manner, a parallel manner, an iterative manner, or a heuristic manner, at least some of the operations may be performed in a different order or be omitted, or other operations may be added.

Meanwhile, the term “unit” or “module” used in the disclosure may include units configured by hardware, software, or firmware, and may be used compatibly with terms, such as, for example, logics, logic blocks, components, circuits, or the like. The term “˜er/or” or “module” may be an integrally configured component or a minimum unit performing one or more functions or a part thereof. For example, the module may be configured by an application-specific integrated circuit (ASIC).

The diverse embodiments of the disclosure may be implemented by software including instructions stored in a machine-readable storage medium (for example, a computer-readable storage medium). A machine may be a device that invokes the stored instruction from the storage medium and may be operated depending on the invoked instruction, and may include the electronic device (for example, the electronic device 100) according to the disclosed embodiments.

In a case where a command is executed by the processor, the processor may directly perform a function corresponding to the command or other components may perform the function corresponding to the command under a control of the processor. The command may include codes created or executed by a compiler or an interpreter.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory, comprising one or more storage media, storing instructions and configured to store information on a neural network model and information on a plurality of resources for performing distributed learning on the neural network model; and
a processor communicatively coupled to the memory and configured to perform a parallelism process including pipeline parallelism, data parallelism, and tensor parallelism based on the information on the neural network model and the information on the plurality of resources,
wherein the instructions, when executed by the processor, cause the electronic device to:
acquire a first computation amount when performing the distributed learning from a time when a change in the plurality of resources is detected to a next checkpoint using the plurality of resources before the change, if the change is detected while performing the distributed learning according to a result of performing the parallelism process,
perform the parallelism process again based on the information on the plurality of changed resources,
acquire a second computation amount when performing the distributed learning from the time when the change is detected to the next checkpoint using the plurality of changed resources, as the result of the parallelism process performed again, and
perform the distributed learning by a method corresponding to a smaller computation amount of the first computation amount and the second computation amount.

2. The electronic device of claim 1, wherein the instructions, when executed by the processor, further cause the electronic device to:
acquire a third computation amount when performing the distributed learning from a checkpoint before the time when the change is detected to the next checkpoint using the plurality of changed resources, as the result of the parallelism process performed again, and
perform the distributed learning by a method corresponding to a smallest computation amount among a sum of a fourth computation amount and the first computation amount, a sum of the fourth computation amount and the second computation amount, and the third computation amount from a previous checkpoint to the time when the change is detected.

3. The electronic device of claim 1, wherein the instructions, when executed by the processor, further cause the electronic device to:
perform the pipeline parallelism to identify a plurality of combinations that allocate the plurality of resources to a plurality of stages that divide layers included in the neural network model,
determine at least one resource performing the data parallelism and at least one resource performing the tensor parallelism among the plurality of resources so that a ratio of the data parallelism is maximized to determine each candidate parallelism method of each of the plurality of combinations,
identify an optimal parallelism method among the candidate parallelism methods as a result of performing the parallelism process based on an execution time of the distributed learning according to each of the candidate parallelism methods identified for each of the plurality of combinations, and
perform the distributed learning on the neural network model based on the optimal parallelism method.

4. The electronic device of claim 3, wherein the instructions, when executed by the processor, further cause the electronic device to:
identify whether there is a resource exceeding memory usage among the plurality of resources when performing the distributed learning according to a first parallelism method in which the ratio of the data parallelism is maximized, and
determine the first parallelism method as the candidate parallelism method when it is identified that there is no resource exceeding the memory usage.

5. The electronic device of claim 4, wherein the instructions, when executed by the processor, further cause the electronic device to:
determine a second parallelism method in which the first parallelism method is changed by reallocating the layers to the plurality of resources so that the memory usage does not exceed when it is identified that there is the resource exceeding the memory usage, and
determine the second parallelism method as the candidate parallelism method.

6. The electronic device of claim 5, wherein the instructions, when executed by the processor, further cause the electronic device to:
determine a third parallelism method having a ratio of the data parallelism that is next higher than that of the first parallelism method when it is identified that there is the resource exceeding the memory usage, and
determine the third parallelism method as the candidate parallelism method.

7. The electronic device of claim 6, wherein the instructions, when executed by the processor, further cause the electronic device to determine the candidate parallelism method among the second parallelism method and the third parallelism method based on the execution time of the distributed learning according to each of the second parallelism method and the third parallelism method.

8. The electronic device of claim 3, wherein, when there is a stage including two or more resources having different performance among a plurality of stages, the instructions, when executed by the processor, further cause the electronic device to allocate the plurality of resources to the plurality of stages based on performances of the two or more resources.

9. The electronic device of claim 3, wherein the information on the plurality of resources includes information on processing performance of each of the plurality of resources, a bandwidth between the plurality of resources, and a bandwidth between the plurality of stages.

10. The electronic device of claim 3, wherein the instructions, when executed by the processor, further cause the electronic device to calculate the execution time by performing the distributed learning on each of candidate parallelism methods for a predetermined time.

11. A method of controlling an electronic device, the method comprising:
performing a parallelism process including pipeline parallelism, data parallelism, and tensor parallelism based on information on a neural network model and information on a plurality of resources for performing distributed learning on the neural network model;
acquiring a first computation amount when performing the distributed learning from a time when a change in the plurality of resources is detected to a next checkpoint using the plurality of resources before the change, if the change is detected while performing the distributed learning according to a result of performing the parallelism process;
performing the parallelism process again based on the information on the plurality of changed resources;
acquiring a second computation amount when performing the distributed learning from the time when the change is detected to the next checkpoint using the plurality of changed resources, as the result of the parallelism process performed again; and
performing the distributed learning by a method corresponding to a smaller computation amount of the first computation amount and the second computation amount.

12. The method of claim 11, further comprising:
calculating a third computation amount when performing the distributed learning from a checkpoint before the time when the change is detected to the next checkpoint using the plurality of changed resources, as the result of the parallelism process performed again; and
performing the distributed learning by a method corresponding to a smallest computation amount among a sum of a fourth computation amount and the first computation amount, a sum of the fourth computation amount and the second computation amount, and the third computation amount from a previous checkpoint to the time when the change is detected.

13. The method of claim 11, further comprising:
performing the pipeline parallelism to identify a plurality of combinations that allocate the plurality of resources to a plurality of stages that divide layers included in the neural network model;
determining at least one resource performing the data parallelism and at least one resource performing the tensor parallelism among the plurality of resources so that a ratio of the data parallelism is maximized to determine each candidate parallelism method of each of the plurality of combinations;
identifying an optimal parallelism method among the candidate parallelism methods as a result of performing the parallelism process based on an execution time of the distributed learning according to each of the candidate parallelism methods identified for each of the plurality of combinations; and
performing the distributed learning on the neural network model based on the optimal parallelism method.

14. The method of claim 13, wherein the determining of each of candidate parallelism methods for each of the plurality of combinations includes:
identifying whether there is a resource exceeding memory usage among the plurality of resources when performing the distributed learning according to a first parallelism method in which the ratio of the data parallelism is maximized; and
determining the first parallelism method as the candidate parallelism method when it is identified that there is no resource exceeding the memory usage.

15. The method of claim 14, wherein the determining of each of the candidate parallelism methods for each of the plurality of combinations includes:
determining a second parallelism method in which the first parallelism method is changed by reallocating the layers to the plurality of resources so that the memory usage does not exceed when it is identified that there is the resource exceeding the memory usage; and
determining the second parallelism method as the candidate parallelism method.

16. The method of claim 15, further comprising:
determining a third parallelism method having a ratio of the data parallelism that is next higher than that of the first parallelism method when it is identified that there is the resource exceeding the memory usage; and
determining the third parallelism method as the candidate parallelism method.

17. The method of claim 16, further comprising:
determining the candidate parallelism method among the second parallelism method and the third parallelism method based on the execution time of the distributed learning according to each of the second parallelism method and the third parallelism method.

18. The method of claim 13, further comprising:
when there is a stage including two or more resources having different performance among a plurality of stages, allocating the plurality of resources to the plurality of stages based on performances of the two or more resources.

19. One or more non-transitory computer-readable storage media storing one or more computer programs including computer-executable instructions that, when executed by one or more processors of an electronic device individually or collectively, cause the electronic device to perform operations, the operations comprising:
performing a parallelism process including pipeline parallelism, data parallelism, and tensor parallelism based on information on a neural network model and information on a plurality of resources for performing distributed learning on the neural network model;
acquiring a first computation amount when performing the distributed learning from a time when a change in the plurality of resources is detected to a next checkpoint using the plurality of resources before the change, if the change is detected while performing the distributed learning according to a result of performing the parallelism process;
performing the parallelism process again based on the information on the plurality of changed resources;
acquiring a second computation amount when performing the distributed learning from the time when the change is detected to the next checkpoint using the plurality of changed resources, as the result of the parallelism process performed again; and
performing the distributed learning by a method corresponding to a smaller computation amount of the first computation amount and the second computation amount.

20. The one or more non-transitory computer-readable storage media of claim 19, the operations further comprising:
calculating a third computation amount when performing the distributed learning from a checkpoint before the time when the change is detected to the next checkpoint using the plurality of changed resources, as the result of the parallelism process performed again; and
performing the distributed learning by a method corresponding to a smallest computation amount among a sum of a fourth computation amount and the first computation amount, a sum of the fourth computation amount and the second computation amount, and the third computation amount from a previous checkpoint to the time when the change is detected.
